(19) United States
(12) Patent Application Publication
(10) Pub. No.: US 2025/0050223 A1
(43) Pub. Date: Feb. 13, 2025

(54) SYSTEMS AND METHODS FOR DIGITAL GOODS ACQUISITION AND TRANSFER

(71) Applicant: Visa International Service Association, San Francisco, CA (US)

(72) Inventor: Michelle Faye DOLLIN, Denver, CO (US)

(73) Assignee: Visa International Service Association, San Francisco, CA (US)

(21) Appl. No.: 18/796,892

(22) Filed: Aug. 7, 2024

Related U.S. Application Data
(60) Provisional application No. 63/518,252, filed on Aug. 8, 2023.

(51) Int. Cl. A63F 13/65; A63F 13/52; G06Q 30/0601; G06T 11/00

(52) U.S. Cl. CPC A63F 13/65; A63F 13/52; G06Q 30/0643; G06T 11/00; G06T 2200/24

(57) ABSTRACT

A computer-implemented method is provided. The method comprises rendering, by a portable electronic device, a digital good in an augmented reality experience of a physical retail store; enabling, by the portable electronic device, a collection of the digital good in the augmented reality experience; rendering, by the portable electronic device, a plurality of virtual environments available for transfer of the digital good; receiving, by the portable electronic device, a user selection of a virtual environment from the plurality of virtual environments; transmitting, by the portable electronic device, a communication for placement of the digital good in the virtual environment, wherein the communication is indicative of the user selection; and rendering, by the portable electronic device, the virtual environment associated with the user selection, to utilize the digital good within the virtual environment. A computer-implemented method for facilitating the use of a digital good with a virtual environment is also provided.

### CROSS-REFERENCE TO RELATED APPLICATION

This application claims the benefit of and priority under 35 U.S.C. § 119(e) to U.S. Provisional Application Ser. No. 63/518,252 filed Aug. 8, 2023, entitled “SYSTEMS AND METHODS FOR DIGITAL GOODS ACQUISITION AND TRANSFER,” the contents of which is hereby incorporated by reference in its entirety herein.

### FIELD

At least some aspects of the present disclosure relate to methods, devices, and systems for facilitating digital goods acquisition in a physical, brick-and-mortar, store, and use of the digital goods in a virtual environment such as, for example, a virtual reality, an augmented reality, and/or a gaming environment.

### SUMMARY

In various aspects, a computer-implemented method is disclosed. In some aspects, the method includes rendering, by a portable electronic device, a digital good in an augmented reality experience of a physical retail store. In some aspects, the method includes enabling, by the portable electronic device, a collection of the digital good in the augmented reality experience. In some aspects, the method includes rendering, by the portable electronic device, a plurality of virtual environments available for transfer of the digital good. In some aspects, the method includes receiving, by the portable electronic device, a user selection of a virtual environment from the plurality of virtual environments. In some aspects, the method includes transmitting, by the portable electronic device, a communication for placement of the digital good in the virtual environment. In certain aspects, the communication is indicative of the user selection. In some aspects, the method includes rendering, by the portable electronic device, the virtual environment associated with the user selection, to utilize the digital good within the virtual environment.

In various aspects, a computer-implemented method is disclosed. In some aspects the method includes acquiring, by a portable electronic device, a digital good in a physical retail store. In some aspects, the method includes transmitting, by the portable electronic device, the digital good to an orchestrator for placement of the digital good in a virtual environment. In some aspects, the method includes accessing, by the portable electronic device, the virtual environment to utilize the digital good within the virtual environment.

In various aspects, a computer-implemented method for facilitating the use of a digital good with a virtual environment is disclosed. In some aspects, the method includes receiving, by a server associated with an orchestrator, a communication request from a portable electronic device, for placement of the digital good in the virtual environment and transmitting, by the server, a communication signal based on the communication request to a publisher of the virtual environment for enabling a rendering, by the portable electronic device, of the virtual environment to utilize the digital good within the virtual environment. In some aspects, the portable electronic device is configured to render a digital good in an augmented reality experience of a physical retail store. In some aspects, the portable electronic device is configured to enable a collection of the digital good in the augmented reality experience through a gamification layer. In some aspects, the portable electronic device is configured to receive a user selection of the virtual environment. In some aspects, the portable electronic device is configured to transmit the communication request based on the user selection.

### BRIEF DESCRIPTION OF THE DRAWINGS

Various features of the aspects described herein are set forth with particularity in the appended claims. The various aspects, however, both as to organization, and methods of operation, together with advantages thereof, may be understood in accordance with the following description taken in conjunction with the accompanying drawings as follows:

The apparatuses and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 is a flow diagram illustrating a method of acquiring a digital good in a physical retail store, and transmitting the digital good into a virtual environment for use in the virtual, in accordance with at least one aspect of the present disclosure.

FIG. 2 is illustrates a system to implement one or more steps of the method of FIG. 1.

FIG. 3 illustrates steps for acquiring the digital good of FIG. 1 through an augmented reality experience within the physical retail store, in accordance with at least one aspect of the present disclosure.

FIG. 4 illustrates a sign-in request associated with the virtual environment of FIG. 1, for transmission of the digital good into the virtual environment, in accordance with at least one aspect of the present disclosure.

FIG. 5 illustrates rendering a webpage associated with the virtual environment of FIG. 1, for transferring the digital good into the virtual environment, in accordance with at least one aspect of the present disclosure.

FIG. 6 is a flow diagram illustrating a method of acquiring a digital good in a physical retail store, and transmitting the digital good into a gaming environment, in accordance with at least one aspect of the present disclosure.

FIG. 7 presents a block diagram of a computer apparatus, according to at least aspect of the present disclosure.

FIG. 8 is a diagrammatic representation of an example system that includes a host machine within which a set of instructions to perform any one or more of the methodologies discussed herein may be executed, according to at least aspect of the present disclosure.

Corresponding reference characters indicate corresponding items throughout the several views. The exemplifications set out herein illustrate various aspects of the present disclosure, in one form, and such exemplifications are not to be construed as limiting the scope of the present disclosure in any manner.

### DETAILED DESCRIPTION

Before explaining various forms of the payment card, it should be noted that the illustrative forms disclosed herein are not limited in application or use to the details of construction and arrangement of components illustrated in the accompanying drawings and description. The illustrative forms may be implemented or incorporated in other forms, variations and modifications, and may be practiced or carried out in various ways. Further, unless otherwise indicated, the terms and expressions utilized herein have been chosen for the purpose of describing the illustrative forms for the convenience of the reader and are not for the purpose of limitation thereof. Also in the following description, it is to be understood that terms such as “forward,” “rearward,” “left,” “right,” “above,” “below,” “upwardly,” “downwardly,” and the like are words of convenience and are not to be construed as limiting terms.

As used herein, a “portable electronic device” may refer to any electronic device that is portable and operated by user. Examples of portable electronic devices include smartphones and other mobile phones (e.g., cellular phones), tablet computers, laptop computers, netbooks, personal music players, e-readers, hand-held specialized readers, mobile Wi-Fi devices, handheld gaming systems, navigation systems, storage devices, portable media players, wearable devices (e.g., fitness bands, smart watches, headphones, earbuds), various electronic devices included in automobiles, and any other electronic device that a user may transport, carry, and/or wear. Other portable electronic devices can include robotic devices, remote-controlled devices, personal-care appliances, and so on. In some embodiments, a portable electronic device constitutes a payment device (e.g., a portable device can store and be able to transmit payment credentials for a transaction).

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Modern consumers are becoming accustomed to spending time in a virtual environment such as, for example, a virtual reality and/or a gaming environment. Consumers are also accustomed to acquiring digital goods online for use within a virtual environment. It can also be desirable to obtain a digital good in a physical retail store. Nonetheless, an interface for transferring the digital good into a virtual environment of the Consumer's choosing is lacking.

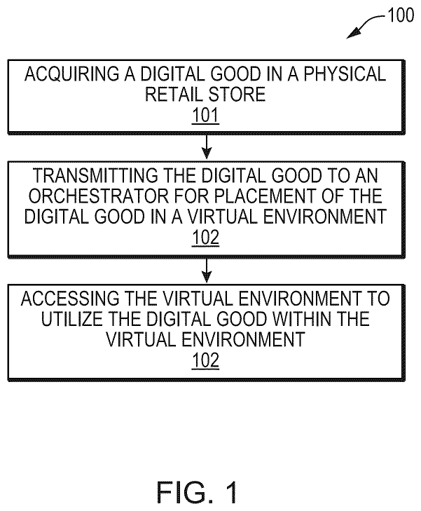

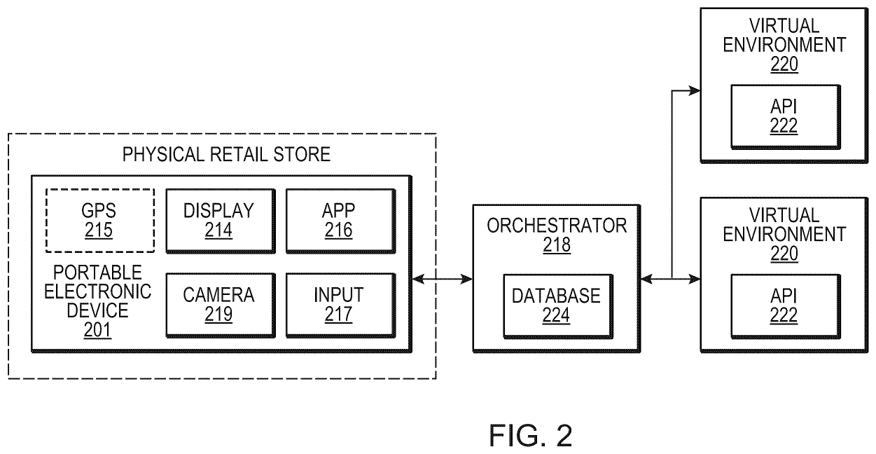

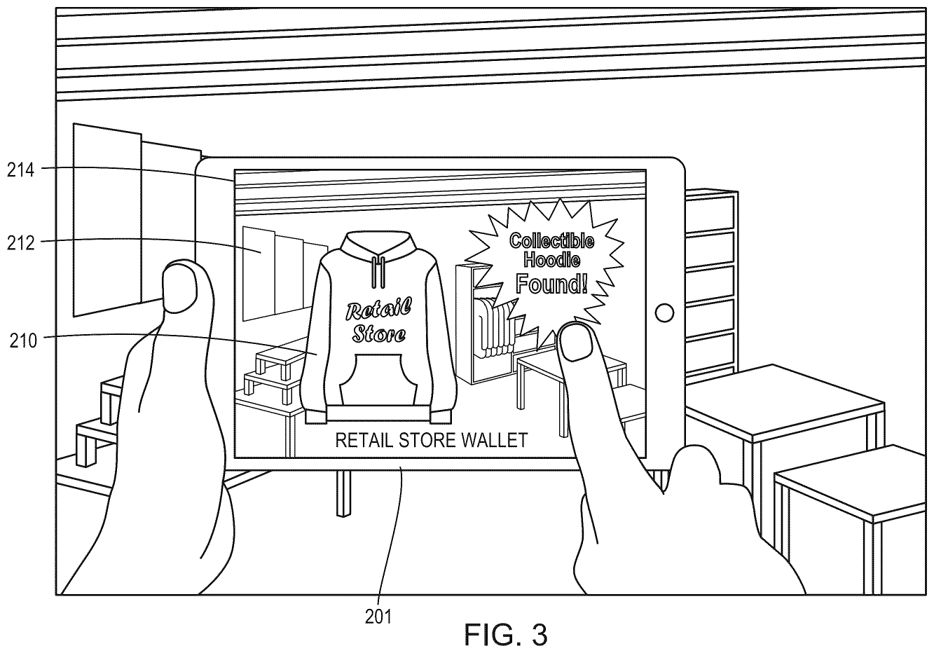

FIG. 1 illustrates a method 100 for acquiring a digital good 212 in a physical retail store, and transferring the digital good 212 for use in a virtual environment 220. FIG. 2 illustrates a system 200 to perform the method 100. The system 200 utilizes a consumer's portable electronic device 201 (FIGS. 2 and 3) to facilitate the acquisition of the digital good, while the consumer shops for physical goods in the physical retail store.

As used herein, the term “digital good” can refer to an image which may be used as an object in an extended or augmented reality environment. For example, a digital good may refer to a rendered or captured image of a physical object, or a rendered image of an object which may or may not actually exist in the physical world. An augmented reality experience may include a digital representation of a physical environment along with a digital good positioned, or overlaid, therein.

In some aspects, the digital good 212 can be a representation of a physical object such as, for example, an article of clothing or a tool to be utilized in the virtual world. In some aspects, the digital goods 212 represent physical goods in the physical retail store.

As illustrated in FIGS. 1 and 3, the method 100 includes acquiring, for example by the portable electronic device 201, a digital good 210 in the physical retail store. In some aspects, the portable electronic device 201 is to present the digital good 210 among other physical goods in the physical retail store. The portable electronic device 201 may render the digital good 210 in an augmented reality experience 212 of the physical retail store. An augmented reality experience is an environment in which reality is augmented with supplemental information that provides additional information to a user that is not available in the physical world.

In some aspects, the portable electronic device 201 includes a display generation component 214 such as, for example, a screen, one or more cameras 219, and an input device 217. Rendering the digital good in the augmented reality experience of the physical retail store may include displaying, by the display generation component 214, a representation of at least a portion of a field of view of the one or more cameras, which includes physical goods in the physical retail store. The representation can be updated as contents of the field of view of the one or more cameras 219 change. The digital good 210 can be concurrently displayed with the representation of the field of view. In some aspects, the digital good 210 is overlaid and/or superimposed onto the representation of the field of view.

In some aspects, the portable electronic device 201 may render the digital good 210 in the augmented reality experience of the physical retail store in a dedicated application 216 of the portable electronic device 201. The application 216 can be associated with the physical retail store such as, for example, a retail store wallet.

In some aspects, the portable electronic device 201 includes a GPS (or GLONASS or other global navigation system) receiver 215, or other location monitoring capabilities, for obtaining information concerning the location of the portable electronic device 201. The GPS receiver 215 may monitor location of the portable electronic device 201 in the physical retail device. Rendering the digital good 210 in the augmented reality experience 212 of the physical retail store can be based on, or triggered by, location of the portable electronic device 201 in the physical retail store. Certain digital goods can be rendered at specific locations in the physical store.

A digital good associated with a predetermined location in the physical retail store can be made to appear, or is rendered, onto the representation of the field of view based on the portable electronic device 201 being at the predetermined location. For example, a virtual hoodie could be presented in the clothing section of the physical retail store, or a digital tool could be presented at a tooling section of the physical retail store.

As illustrated in FIG. 3, the portable electronic device 201 may introduce a gamification layer for collecting/acquiring the digital good 212 after it is rendered onto the representation of the field of view of the one or more cameras of the portable electronic device 201 in the physical retail store. The consumer may interact with the digital good 212 via on or more inputs of the portable electronic device 201. In one example, as illustrated in FIG. 3, the consumer may acquire/collect the digital good 212 via a swipe input, a tap input, or a sequence of swipe inputs and/or tap inputs.

In some examples, the gamification layer presents additional virtual objects onto the representation of the field of view such as a hoop. The consumer may drag the digital good 212 into the hoop to acquire/collect the digital good 212, for example. In another example, the consumer may throw a digital lasso to capture the digital good 212.

Referring primarily to FIGS. 1, 2, and 4, the method 100 further includes transmitting 102 the acquired/collected digital good 212 to an orchestrator 218 for placement of the digital good 212 in a virtual environment 220. In some aspects, the orchestrator 218 is a computer server that provides an interface between the consumer's portable electronic device 212, and one or more virtual environments 220. In a preliminary registration process, the retail store may select certain digital goods for presenting onto a consumer's portable electronic device 201, while in the physical retail store, and/or select from a plurality of virtual environments 220 that are to receive the digital goods after collection by the consumer's portable electronic device 201.

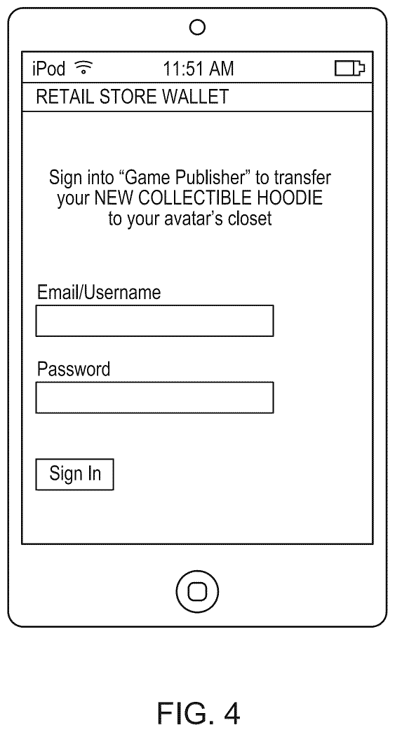

In some aspects, the orchestrator 218 stores a database 224 of digital goods 212 and corresponding virtual environments 220, where the digital goods 212 can be used. Following successful acquisition of the digital good 212, the portable electronic device 212, through an application associated with the physical retail store, may prompt the consumer to select a virtual environment 220 for placement of the digital good 212. In the example illustrated in FIG. 4, the consumer is prompted to provide credentials for accessing the virtual environment 220. Upon successful log-in, the orchestrator 218 connects the consumer with the virtual environment 220. In some aspects, the orchestrator 218 transmits an SSO request to the virtual environment 220. The virtual environment 220 may host an API 222 that enables SSO, thereby permitting the consumer to log into the virtual environment 220 through the physical retail store application 216.

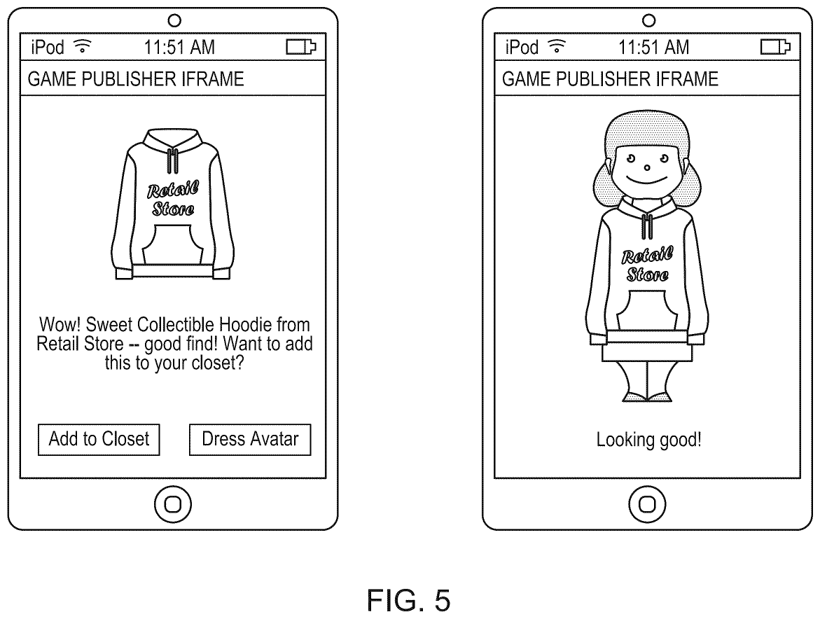

The method 100 further includes accessing, by the portable electronic device 201, the virtual environment 220 to utilize the digital good 212 within the virtual environment 220. As illustrated in FIG. 5, the virtual environment 220 may then render a webpage for transferring the digital good 212. The virtual environment webpage can be, for example, rendered onto the retail store application via iFrame or WebView. Alternatively, the consumer may share credentials such as an email address associated with a selected virtual environment for a later transfer of the digital good.

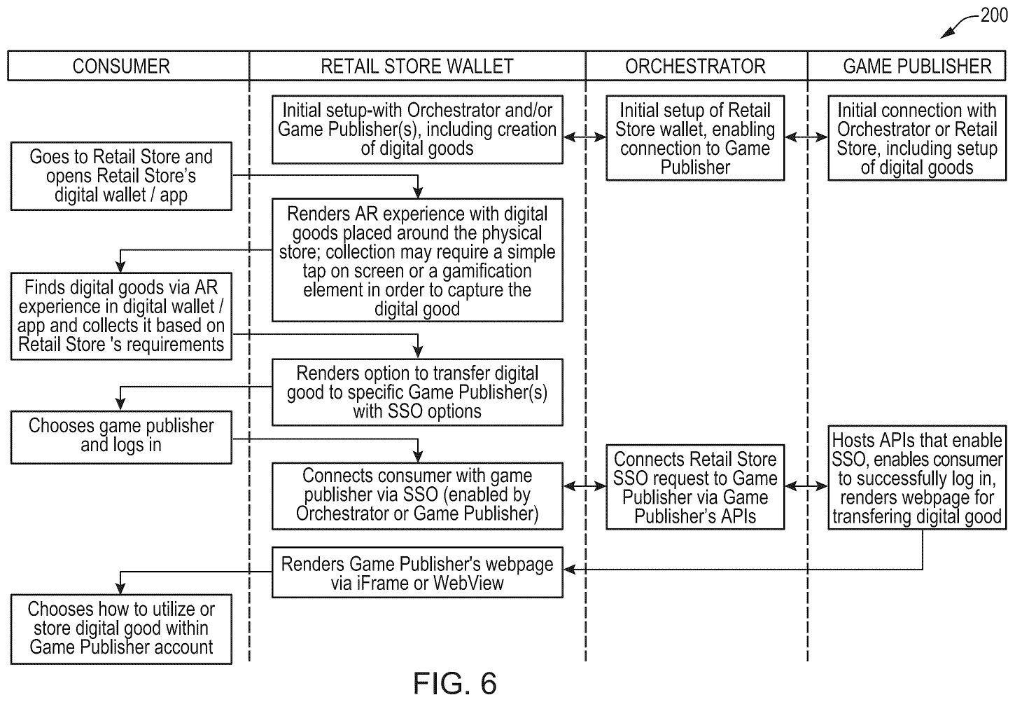

FIG. 6 illustrates a method 200 similar in many respects, which are not repeated herein for brevity, to the method 100. The method 200 specifically addresses acquiring of a digital good in a physical retail store, and transmission of the digital good to a game publisher for use in a digital game. The method 200 outlines interactions between the retail store wallet of the portable electronic device 201, the orchestrator 218, and the game published, based on inputs by the consumer.

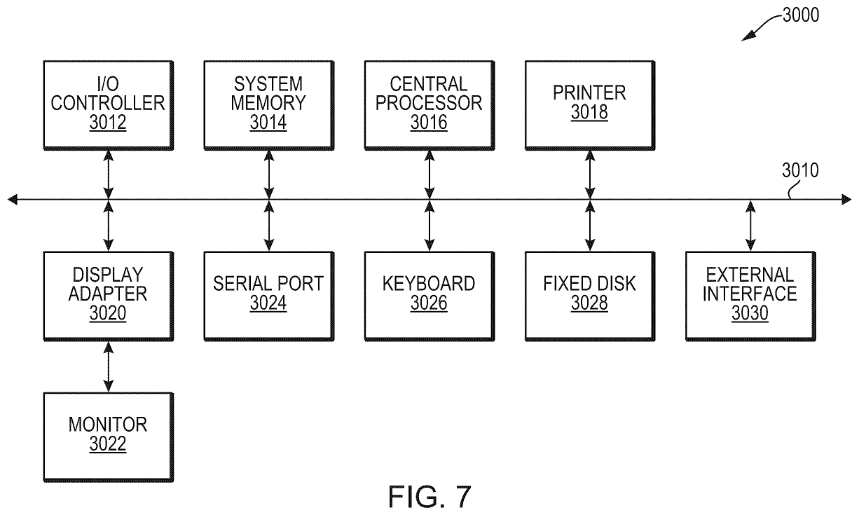

FIG. 7 is a block diagram of a computer apparatus 3000 with data processing subsystems or components, according to at least one aspect of the present disclosure. The subsystems shown in FIG. 7 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

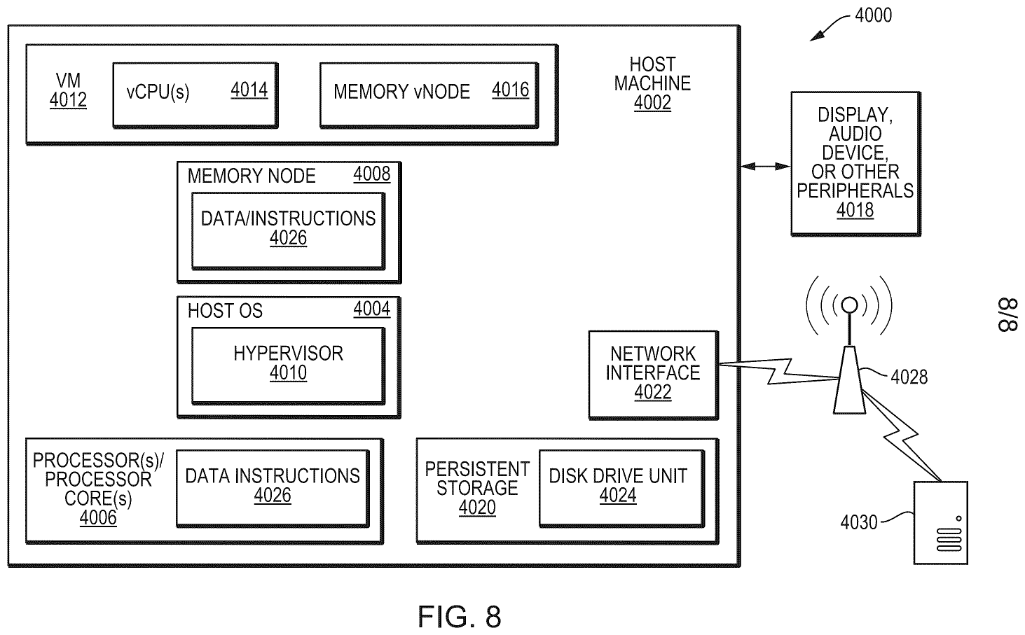

FIG. 8 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 4002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to the corresponding vNode 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AlN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4028 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.

Clause 1. A computer-implemented method, comprising: rendering, by a portable electronic device, a digital good in an augmented reality experience of a physical retail store; enabling, by the portable electronic device, a collection of the digital good in the augmented reality; rendering, by the portable electronic device, a plurality of virtual environments available for transfer of the digital good; receiving, by the portable electronic device, a user selection of a virtual environment from the plurality of virtual environments; transmitting, by the portable electronic device, a communication for placement of the digital good in the virtual environment, wherein the communication is indicative of the user selection; and rendering, by the portable electronic device, the virtual environment associated with the user selection, to utilize the digital good within the virtual environment.

Clause 2. The computer-implemented method of clause 1, wherein rendering the digital good in the augmented reality experience of the physical retail store comprises generating, by a display generation component of the portable electronic device, a representation of at least a portion of a field of view of one or more cameras of the portable electronic device, which includes physical goods in the physical retail store, wherein the representation is updated as contents of the field of view of the one or more cameras change.

Clause 3. The computer-implemented method of clause 2, wherein rendering the digital good in the augmented reality experience of the physical retail store further comprises overlaying the digital good onto the representation.

Clause 4. The computer-implemented method of any one of clauses 1-3, further comprising monitoring a location of the portable electronic device in the physical retail store, wherein the rendering of the digital good is based on the monitored location of the portable electronic device in the physical retail store.

Clause 5. The computer-implemented method of any one of clauses 1-4, wherein the communication is transmitted to a publisher of the virtual environment associated with the user selection.

Clause 6. The computer-implemented method of clause 5, wherein the communication is transmitted via an orchestrator.

Clause 7. The computer-implemented method of clause 5 or 6, wherein the communication is transmitted via an orchestrator.

Clause 8. The computer-implemented method of any one of clauses 1-7, wherein the collection of the digital good in the augmented reality is achieved through a gamification layer.

Clause 9. The computer-implemented method of clause 8, wherein the portable electronic device comprises an input device, and wherein the collection of the digital good comprises at least one of a tap input or a swipe input.

Clause 10. The computer-implemented method of any one of clauses 1-9, wherein the virtual environment associated with the user selection comprises a digital game.

Clause 11. The computer-implemented method of any one of clauses 1-10, wherein the digital good is associated with a physical good in the physical retail store.

Clause 12. A computer-implemented method, comprising: acquiring, by a portable electronic device, a digital good in a physical retail store; transmitting, by the portable electronic device, the digital good to an orchestrator for placement of the digital good in a virtual environment; and accessing, by the portable electronic device, the virtual environment to utilize the digital good within the virtual environment.

Clause 13. The computer-implemented method of clause 12, wherein acquiring the digital good comprises: presenting, by the portable electronic device, the digital good among other physical goods in the physical retail store; facilitating, by the portable electronic device, a retrieval of the digital good.

Clause 14. The computer-implemented method of clause 13, wherein presenting the digital good comprises overlaying the digital good onto a livestream of a camera of the portable electronic device.

Clause 15. The computer-implemented method of clause 14, wherein presenting the digital good comprises: monitoring a location of the portable electronic device in the physical retail store; and overlaying the digital good onto the livestream based on the location of the portable electronic device.

Clause 16. The computer-implemented method of any one of clauses 13-15, wherein facilitating the retrieval of the digital good comprises overlaying a gamification layer onto the livestream.

Clause 17. A computer-implemented method for facilitating the use of a digital good with a virtual environment. The computer-implemented method comprises receiving, by a server associated with an orchestrator, a communication request from a portable electronic device, for placement of the digital good in the virtual environment and transmitting, by the server, a communication signal based on the communication request to a publisher of the virtual environment for enabling a rendering, by the portable electronic device, of the virtual environment to utilize the digital good within the virtual environment. The portable electronic device is configured to render a digital good in an augmented reality experience of a physical retail store; enable a collection of the digital good in the augmented reality experience through a gamification layer; receive a user selection of the virtual environment; and transmit the communication request based on the user selection.

Clause 18. The computer-implemented method of clause 17, wherein the communication request is a SSO request.

Clause 19. The computer-implemented method of clause 17 or 18, wherein the communication request is transmitted via an API hosted by the publisher for enabling a login by the portable electronic device to the virtual environment.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A computer-implemented method, comprising:
rendering, by a portable electronic device, a digital good in an augmented reality experience of a physical retail store;
enabling, by the portable electronic device, a collection of the digital good in the augmented reality experience;
rendering, by the portable electronic device, a plurality of virtual environments available for transfer of the digital good;
receiving, by the portable electronic device, a user selection of a virtual environment from the plurality of virtual environments;
transmitting, by the portable electronic device, a communication for placement of the digital good in the virtual environment, wherein the communication is indicative of the user selection; and
rendering, by the portable electronic device, the virtual environment associated with the user selection, to utilize the digital good within the virtual environment.

2. The computer-implemented method of claim 1, wherein rendering the digital good in the augmented reality experience of the physical retail store comprises generating, by a display generation component of the portable electronic device, a representation of at least a portion of a field of view of one or more cameras of the portable electronic device, wherein the representation is updated as contents of the field of view of the one or more cameras change.

3. The computer-implemented method of claim 2, wherein rendering the digital good in the augmented reality experience of the physical retail store further comprises overlaying the digital good onto the representation.

4. The computer-implemented method of claim 1, further comprising monitoring a location of the portable electronic device in the physical retail store, wherein rendering the digital good is based on the monitored location of the portable electronic device in the physical retail store.

5. The computer-implemented method of claim 1, wherein the communication is transmitted to a publisher of the virtual environment associated with the user selection.

6. The computer-implemented method of claim 5, wherein the communication is transmitted via an orchestrator.

7. The computer-implemented method of claim 5, wherein the communication comprises a single sign-on (SSO) request.

8. The computer-implemented method of claim 1, wherein the collection of the digital good in the augmented reality is achieved through a gamification layer.

9. The computer-implemented method of claim 8, wherein the portable electronic device comprises an input device, and wherein the collection of the digital good comprises at least one of a tap input or a swipe input.

10. The computer-implemented method of claim 1, wherein the virtual environment associated with the user selection comprises a digital game.

11. The computer-implemented method of claim 1, wherein the digital good is associated with a physical good in the physical retail store.

12. A computer-implemented method, comprising:
acquiring, by a portable electronic device, a digital good in a physical retail store;
transmitting, by the portable electronic device, the digital good to an orchestrator for placement of the digital good in a virtual environment; and
accessing, by the portable electronic device, the virtual environment to utilize the digital good within the virtual environment.

13. The computer-implemented method of claim 12, wherein acquiring the digital good comprises:
presenting, by the portable electronic device, the digital good among other physical goods in the physical retail store; and
facilitating, by the portable electronic device, a retrieval of the digital good.

14. The computer-implemented method of claim 13, wherein presenting the digital good comprises overlaying the digital good onto a livestream of a camera of the portable electronic device.

15. The computer-implemented method of claim 14, wherein presenting the digital good comprises:
monitoring a location of the portable electronic device in the physical retail store; and
overlaying the digital good onto the livestream based on the location of the portable electronic device.

16. The computer-implemented method of claim 14, wherein facilitating the retrieval of the digital good comprises overlaying a gamification layer onto the livestream.

17. A computer-implemented method for facilitating the use of a digital good with a virtual environment, comprising:
receiving, by a server associated with an orchestrator, a communication request from a portable electronic device, for placement of the digital good in the virtual environment, wherein the portable electronic device is configured to:
render a digital good in an augmented reality experience of a physical retail store;
enable a collection of the digital good in the augmented reality experience through a gamification layer;
receive a user selection of the virtual environment; and
transmit the communication request based on the user selection; and
transmitting, by the server, a communication signal based on the communication request to a publisher of the virtual environment for enabling a rendering, by the portable electronic device, of the virtual environment to utilize the digital good within the virtual environment.

18. The computer-implemented method of claim 17, wherein the communication request is a single sign-on (SSO) request.

19. The computer-implemented method of claim 17, wherein the communication request is transmitted via an API hosted by the publisher for enabling a login by the portable electronic device to the virtual environment.
